(19) United States
(12) Patent Application Publication
(10) Pub. No.: US 2008/0128078 A1
(43) Pub. Date: Jun. 5, 2008

(54) CURIE TEMPERATURE CONTROLLED INDUCTION HEATING

(75) Inventors: Tom May, Bonney Lake, WA (US); Mark S. Wilenski, Seattle, WA (US)

Correspondence Address: MCNEES WALLACE & NURICK LLC, 100 PINE STREET, P.O. BOX 1166, HARRISBURG, PA, 17108-1166, US

(73) Assignee: THE BOEING COMPANY, Chicago, IL (US)

(21) Appl. No.: 11/565,900

(22) Filed: Dec. 1, 2006

(51) Int. Cl. B29C 35/08

(52) U.S. Cl. 156/272.4

(57) ABSTRACT

A heating apparatus and a method for using a heating apparatus for repairing composite structures. The heating apparatus includes a high temperature matrix having magnetic particles therein. The magnetic particles have a predetermined Curie temperature. The apparatus also includes a coil in communication with a power source. The coil is disposed adjacent the matrix and magnetic particles. The coil provides an alternating current sufficient to heat the magnetic particles up to about the predetermined Curie temperature. The method utilizes the uniform heat provided by the heating apparatus to bond a repair patch to a composite material.

### TECHNICAL FIELD

The disclosure is directed to heating methods and apparatus, and in particular, is directed to methods for providing heat and a heating apparatus for providing controlled and uniform temperatures over a surface area.

### BACKGROUND

Aircraft may include components that are fabricated from a composite or metallic material. These materials may be exposed to conditions that are capable of damaging the surface of the material. Such conditions may include temperature variations, weather, including frozen precipitation, birds or other flying objects, on-ground service equipment and personnel. The surface damage may include abrasions, cracks, or punctures to name a few. This damage may need repair.

Large components, including those components present on an aircraft, may be too large or logistically very difficult to repair with the current techniques and apparatus. In these situations, repairs to aircraft surfaces may be performed portably on the surface of the aircraft without removal of the damaged component. However, despite the need to repair the surface of the aircraft in-place, the repairs must be performed in a repeatable, controlled manner in order to provide a repeatable and predictable repair that permits continued operation of the aircraft.

Repairs may include placing a patch on the surface to be repaired and subsequently heating the patch to a temperature that bonds the patch to the surface. Current methods used for applying heat for a repair may include, but is not limited to, the use of resistance heated blankets, heat guns, or infrared heating. Heat blankets and other heat sources used for repairing composite structures may have difficulty achieving and maintaining a uniform temperature over non-uniform structure. Non-uniform heating causes both residual stresses and non-uniform repair properties, in addition to forcing the use of longer repair cycles.

What is needed is a repair method and apparatus that uniformly heats the repair area to a desired temperature, wherein the apparatus is portable, reusable and heats without damaging the underlying substrate.

### SUMMARY

One embodiment includes a heating apparatus for providing uniform heating across a surface. The heating apparatus includes a high temperature matrix having magnetic particles therein. The magnetic particles have a predetermined Curie temperature. The apparatus also includes a coil or coils in operatively coupled to a power source. The coil is disposed near or embedded in the matrix and magnetic particles. The coil provides an alternating current that causes an alternating magnetic field sufficient to heat the magnetic particles up to about the predetermined Curie temperature.

Another embodiment includes a method for applying a repair patch to a damaged substrate surface. The repair patch includes an uncured matrix material and/or adhesive. A heating apparatus, according to an embodiment may be applied adjacent to at least a portion of the repair patch. An alternating current causing an alternating magnetic field is provided to the coil or coils of the heating apparatus sufficient to heat the magnetic particles up to about the predetermined Curie temperature. The composite patch is then cured with heat generated by the heating apparatus.

An advantage of the heating apparatus according to an embodiment includes allowing a repair area to be heated to a very specific temperature with a substantially uniform temperature across the surface of the apparatus.

Another advantage of the heating apparatus according to an embodiment includes substantially uniform temperatures across the surface of the apparatus on a variety of substrates having varying compositions, geometries and structures.

Still another advantage of the method and apparatus according to an embodiment is that the repair area may be heated very quickly to the desired cure temperature.

Still another advantage of the method and apparatus according to an embodiment is that conventional repair material may be utilized and improved repair qualities may be achieved.

Still another advantage of the method and apparatus according to an embodiment is that the apparatus may be configurable to provide a variety of temperatures, and in a variety of geometries.

Still another advantage of an embodiment may be that the temperature control provided by the apparatus will improve the quality of repairs while reducing the repair cycle time.

Still another advantage of an embodiment may be that the risk of potential overheating or underheating the repair is reduced and the capability to evenly heat a broader range of structures will be increased.

Other features and advantages presented in the disclosure will be apparent from the following more detailed description of the preferred embodiment, taken in conjunction with the accompanying drawings which illustrate, by way of example, the principles of the disclosure.

### BRIEF DESCRIPTION OF THE DRAWINGS

FIG. 1 shows an elevational cross-sectional illustration of a heating apparatus according to an embodiment.

FIG. 2 shows an elevational cross-sectional illustration of a heating apparatus according to another embodiment.

FIG. 3 shows a cutaway top-illustration of a heating apparatus according to an embodiment.

FIG. 4 shows an elevational cutaway illustration of a heating apparatus according to an embodiment applied to a damaged substrate.

FIG. 5 shows an elevational cutaway illustration of a heating apparatus according to another embodiment applied to a damaged substrate.

FIG. 6 shows an elevational cutaway illustration of a heating apparatus according to still another embodiment applied to a damaged substrate.

FIG. 7 shows a perspective illustration of a damaged substrate having a cylindrical geometry.

FIG. 8 shows a perspective illustration of the damaged substrate of FIG. 5 with a repair patch applied.

FIG. 9 shows a perspective illustration of the damaged substrate of FIG. 6 with a heating apparatus applied.

Wherever possible, the same reference numbers are used throughout the drawings to refer to the same or like parts.

### DETAILED DESCRIPTION

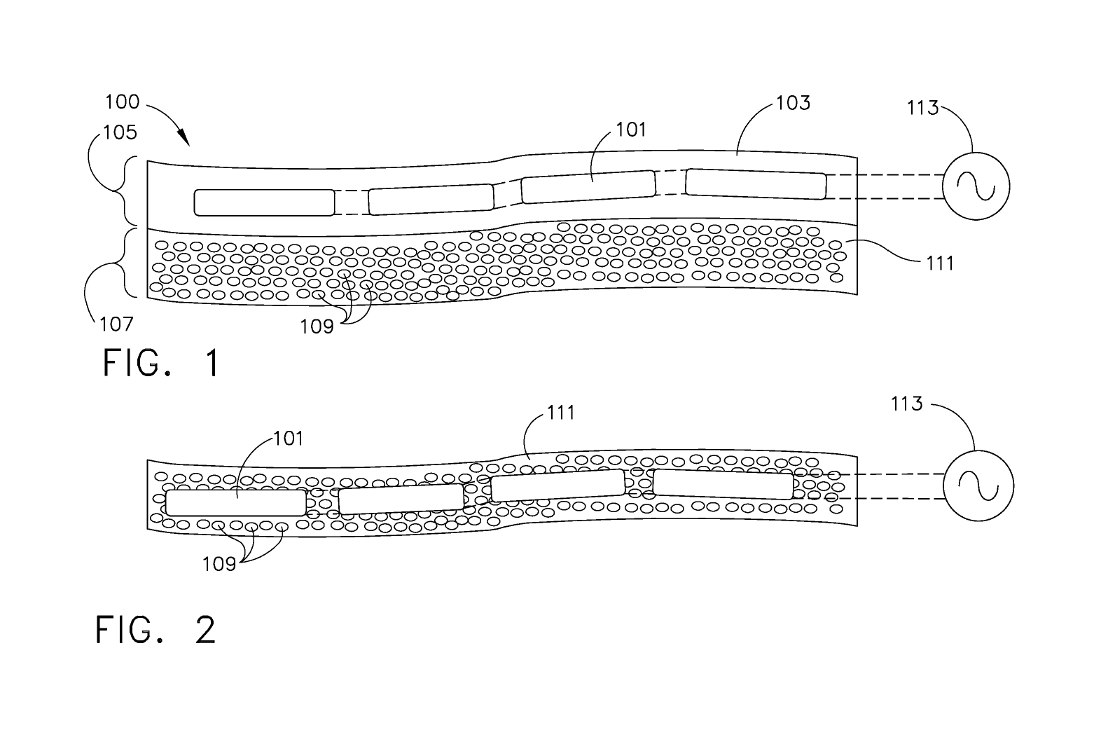

FIG. 1 shows a heating apparatus 100 according to an embodiment of the disclosure. The heating apparatus 100 includes a coil component 105 and a heating component 107. This embodiment includes a coil component 105 having a coil 101 embedded in a high temperature matrix 103, preferably a flexible high temperature matrix 103. Coil 101 may preferably be an induction coil in communication with an alternating current (AC) power source 113. Coil 101 may be configured in a substantially co-planar arrangement adjacent to the heating component 107. The heating component 107 includes a plurality of magnetic particles 109 embedded in a high temperature matrix 111. High temperature matrix 111 may be the same or may be different than the high temperature matrix 103. Although a flexible high temperature matrix is preferred, high temperature matrix 103,111 may be a rigid material, such as a ceramic. The configuration, including a coil component 105 and heating component 107, permits the repair or removal of the individual components and allows easy manufacture of the separate components. The coil component 105 and heating component 107 may be unitary, attached or separable. The power source 113 provides the alternating current through the coil 101 and generates an alternating magnetic field within the coil 101. The power source 113 preferably may provide a sufficiently high frequency to provide hysteresis heating to magnetic particles 109.

While not wishing to be bound by theory or mechanism, magnetic particles 109 may resist the changing magnetic fields in the nearby coil 101, resulting in hysteresis heating within the magnetic particles 109 that heats the magnetic materials. The heating due to hysteresis heating of the magnetic particles 109 continues until a temperature at or about the Curie temperature of the particular magnetic particles 109.

The magnetic particles 109 maintain the Curie temperature because hysteresis heating substantially ceases at or above the Curie temperature, thereby limiting and controlling the temperature to which the magnetic particles 109 are heated. Further, because hysteresis heating only occurs at temperatures about or below the Curie temperature, so long as the magnetic particles are exposed to the changing magnetic field, the temperature of the magnetic particles 109 exposed to the alternating magnetic field induced by coil 101 maintains a uniform temperature at or near the Curie temperature without substantial variations across the material. Materials having magnetic properties corresponding to a larger area under a B-H loop of the corresponding material hysteresis curve have increased rates of hysteresis heating when exposed to alternating magnetic fields. The area under the B-H loop is related to the amount of heat generated by the magnetic particles exposed to the alternating magnetic field during each cycle of the alternating magnetic field. Therefore, materials having magnetic properties corresponding to larger areas under a B-H loop allows greater heating efficiency and decreased time to reach the Curie temperature. Larger areas under the B-H loop may be provided, for example, with material having larger coercivity, larger magnetic permeability, higher maximum magnetic fields or combinations of these properties.

The coil 101 configuration and the power from power source 113, including the alternating current frequency, may provide an alternating magnetic field that provides hysteresis heating to the magnetic particles 109, but little or no excess heating of the underlying substrate through mechanisms such as eddy current heating. Suitable frequencies include, but are not limited to, about 400 Hz to about 100 MHz, preferably from about 3 kHz to about 10 MHz. In addition, a combination of a predetermined area under the B-H loop and a power source frequency may be provided to provide a desired maximum or operating temperature and the desired rate and efficiency to the maximum or operating temperature.

The magnetic materials making up the magnetic particles 109 include material that have a predetermined Curie temperature. Curie temperature, as used herein, is the temperature at which a material loses characteristic magnetic properties. The Curie temperature may include a temperature or range of temperatures in which the ferromagnetic ability is reduced or becomes zero. Materials particularly suitable for use with an embodiment may include material having a well-defined Curie temperature (wherein the temperature range at which the net magnetization reduced from the bulk ferromagnetic value of the material to a net magnetization of zero is over a small temperature range). That is, the Curie temperature is preferably a single temperature or a narrow range of temperatures.

Magnetic particles 109 may include any magnetic material having a Curie temperature corresponding to the desired operating temperature of the heating apparatus 100. In addition, suitable magnetic materials 109 preferably have a combination of sufficiently large area under the B-H loop and a sufficiently high power source frequency that provides the desired operating temperature and the rate and efficiency to the desired operating temperature.

For example, a heating apparatus 100 configured for operation at temperatures of 250-300° F. may include materials having a Curie temperature of about 300° F. Suitable materials include magnetic materials having a Curie temperature selected from a temperature or narrow range of temperatures between about room temperature and about 650° F., preferably a temperature or narrow range of temperatures between about 160° F. to about 650° F., and more preferably a temperature or narrow range of temperatures between from about 250 to about 350° F.

In addition, suitable material preferably have a combination of sufficiently large area under the B-H loop that when exposed to a power source 113 frequency, the material provides hysteresis heating to a desired maximum temperature and a desired rate and efficiency of heating to the maximum temperature. While not provided as a limitation, suitable magnetic materials may include magnetite, CuNiFe alloys (e.g., 20 wt % Fe-20 wt % Ni-60 wt % Cu alloy), samarium containing magnetic materials (e.g., Sm₂Fe₁₇, Sm—Co—X, or Sm—Fe—X, wherein X is an additive element such as B, Mn, or N) and neodymium containing magnetic materials (e.g., Nd₂Fe₁₇ or Nd—Fe—X, wherein X is an additive element such as B, Co, Mn, or N). For example, Sm₂Fe₁₇ includes Curie temperature of about 125° C. and the Nd₂Fe₁₇ includes a Curie temperature of about 60° C. However, Curie temperatures of materials may vary with respect to composition and/or processing, such as heat treatment. Further, a larger the amount of magnetic particles 109 provided within the high temperature matrix 111 results in a greater amount of heat generation due to hysteresis heating. Materials having higher Curie temperatures, including Curie temperatures of up to 650° F. and above may also be utilized. The high temperature matrix 111 and 103 provided may be a high temperature resistant material that permits exposure of the magnetic particles 109 to the alternating magnetic field formed by the coil 101. Magnetic materials may include ferromagnetic, ferrimagnetic, paramagnetic, superparamagnetic or any other magnetic material.

FIG. 2 shows an alternate configuration of the heating apparatus 100 according to an embodiment. The coil 101 and magnetic particles 109 are embedded in the high temperature matrix 111. Coil 101 may be embedded in magnetic particles 109. This may permit more uniform exposure of the magnetic particles 109 to the electromagnetic field, and thus provide more efficient heating. The integration of the components may also permit a reduced thickness and unitary construction that increases portability.

High temperature matrices 103 and 111 may each be fabricated from a high temperature material that is sufficiently pliable to permit bending to conform to a variety of geometries. It may also be resistant to the temperatures equal to or greater than the Curie temperatures of the magnetic particles 109. In addition, the high temperature matrix 103 may be formable in a manner that permits embedding the coil 101 and/or the magnetic particles 109. For example, embedding may take place using any suitable method including, but not limited to, coextrusion of the embedded material, formation of the matrix with the magnetic particles 109 and/or the coil 101 included therein, and perforations in the formed material into which the magnetic particles 109 and/or the coil 101 are placed. Suitable matrix materials include, but are not limited to, high temperature non-electrically conductive thermoplastics, such as polyetheretherketone (PEEK) and polyetherketoneketone (PEKK). Other higher temperature applications, including temperatures greater than about 650° F., may include rigid materials, such as ceramic materials, that are capable of incorporating the coil 101 and/or magnetic particles 109.

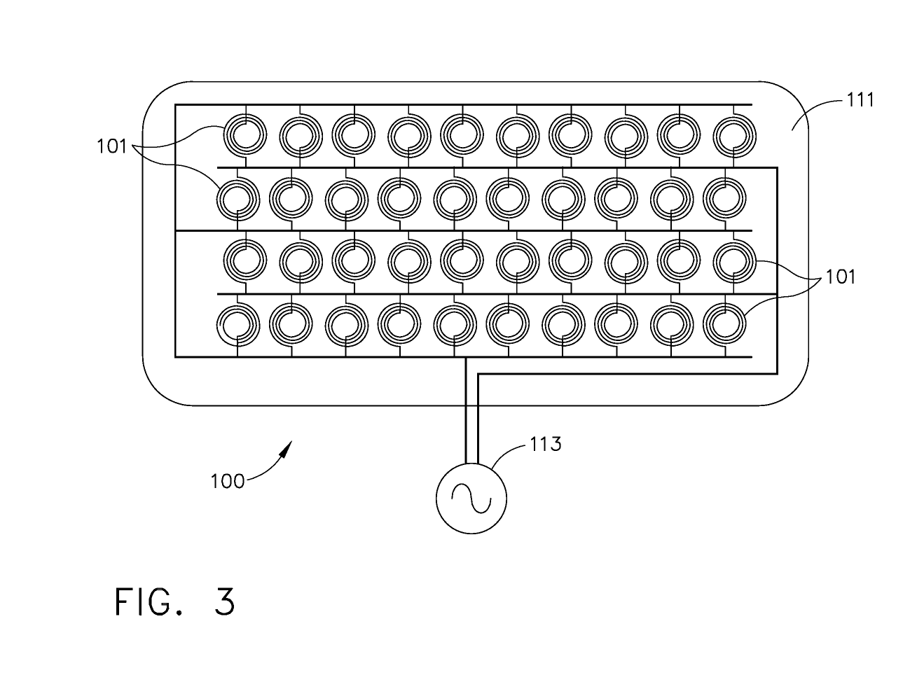

FIG. 3 shows a configuration of coil 101 from a cutaway top-view. The apparatus of an embodiment is shown in FIG. 3 and may include a coil 101 or a plurality of coils 101. In a preferred embodiment, the heating apparatus 100 may include a plurality of coils 101, wherein the coils may include a plurality of wraps or windings. The arrangement of the coils 101 may be any arrangement that provides the alternating magnetic field that results in hysteresis heating to magnetic particles 109. The arrangement may include coils 101 arranged in a manner permitting electron flow through a series arrangement of coils 101, or through a parallel arrangement of coils 101.

As shown in FIG. 3, the coils 101 are arranged with alternating coil directions (i.e., right hand direction oriented coil adjacent to left hand direction oriented coil). However, the coils may be oriented in a single direction or any combination of directions. Coils 101 may include multiple loop structures arranged substantially parallel to the heating component 107 having the embedded magnetic particles 109 (not shown in FIG. 3).

The loop structure of coil 101 is not limited to the number of coils shown in FIG. 3 and may include any number of loops that provide the desired alternating magnetic field when provided with power from power source 113. The power source 113 may further include a controller 301 to control the amount of current and/or frequency provided to coil 101 and/or control the current provided to the plurality of coils 101 resulting in additional control of the temperature within the heating apparatus 100. While not required, cooling may be provided to coil 101 by any suitable technique. For example, cooling may be provided by fluid flow through the coil 101 or by other suitable coil cooling mechanisms.

The heating apparatus 100 may be utilized in any application requiring specific temperatures over a predetermined surface area, wherein the temperatures may be reached quickly and are substantially uniform over the predetermined surface area. The heating apparatus 100 according to an embodiment may be preferably usable in the application of repair patches to damaged surfaces of aircraft components or mobile platforms. The heating apparatus 100 of an embodiment may also be utilized in other applications requiring heating, such as, defrosting of pipes or other structures.

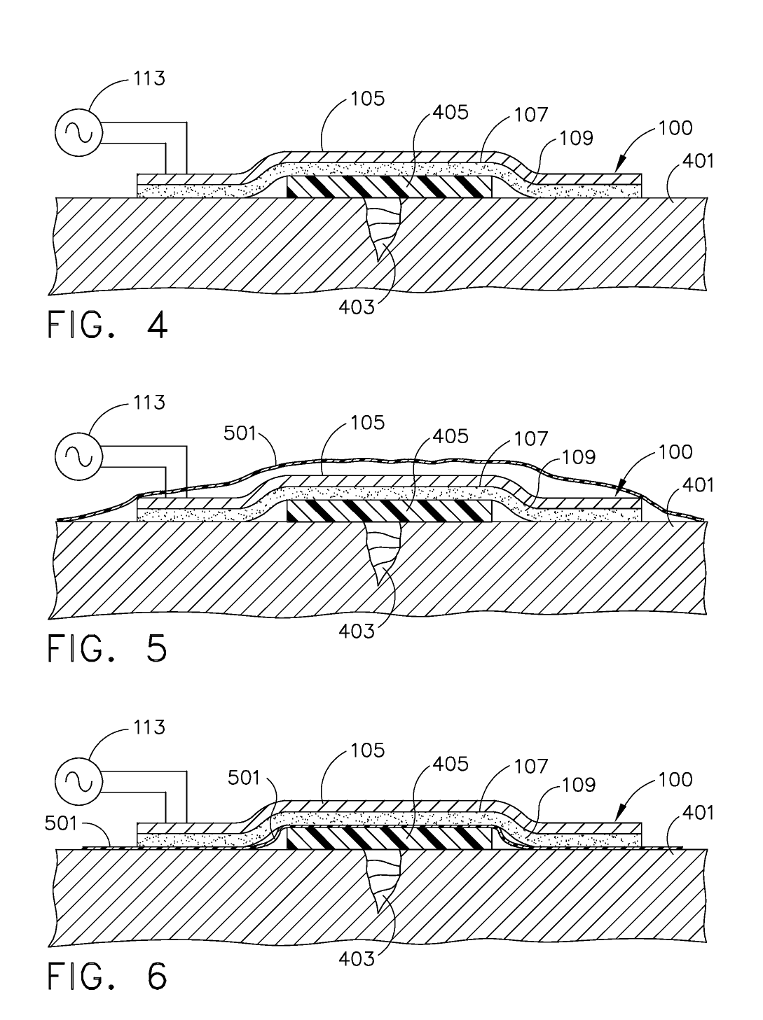

An embodiment of the disclosure may also include a method for repairing a damaged substrate. FIG. 4 shows a cross-section of a damaged substrate 401 having damage 403, wherein a patch 405 and heating apparatus 100 have been applied. To repair the damaged substrate 401, the repair patch 405 is placed over the damaged surface, shown as damage 403 in FIG. 4. Damage 403 may include abrasions, cracks, punctures or other types of damage to the surface. The repair patch 405 may be any conventional repair patch suitable for providing a repaired surface for the underlying damaged substrate 401. In a preferred embodiment, the repair patch 405 has material that, when cured, may be similar or substantially identical in structure and material to the underlying damaged substrate 401.

For example, the repair patch 405 may be fabricated from a thermoset or thermoplastic material, such as, an epoxy, bismalemide, cyanate ester or polyimide resin matrix, among others. If desired, such as in the event of a larger damaged area, reinforcing fibers, may be included in the repair patch 405. The reinforcing fibers are preferably the same type of reinforcing fibers present in the damaged underlying substrate 401. Reinforcing fibers may include, but are not limited to, carbon or graphite fibers, boron fibers, silicon carbide fibers, glass fibers, or organic fibes (e.g., KELVAR® or SPECTRA®) or any other suitable reinforcing fiber. KELVAR® is a federally registered trademark of E. I. du Pont de Nemours and Company, Wilmington, Del. for synthetic fiber. SPECTRA® is a federally registered trademark of Honeywell International Inc., Morristown, N.J. for polyethylene fiber.

Repair patch 405 may also preferably include an adhesive to increase bonding of the repair patch 405 to the surface. The repair patch 405 may be any suitable geometry that may cover the area to be repaired. Preferably it may be tailored to relatively closely match the damaged area.

Once the repair patch 405 is placed on the damaged area, the heating apparatus 100 is placed over the damaged substrate 401 and repair patch 405. The cross-section shown in FIG. 4 illustrates the coil component 105 and the heating component 107 of the heating apparatus 100, wherein the heating component 107 has been applied adjacent to the repair patch 405. The heating apparatus 100 preferably has sufficient flexibility to substantially conform to the repair patch 405 and provide sufficient coverage to uniformly heat the repair patch 405 and conduct a cure cycle to cure the materials within the repair patch 405.

As shown in FIG. 4, the heating apparatus 100 may be configured to also function as a vacuum bag. When sealed to substrate 401, a vacuum may be drawn between heating apparatus 100 and substrate 401. The vacuum apparatus 100 may exert sufficient force on the underlying structure, including patch 405, to assist in removal of gaseous voids and/or solvent from the repair during the heat and/or cure cycle.

FIG. 5 includes the damaged substrate 401 having damage 403, patch 405 and heating apparatus 100. As shown in the embodiment of FIG. 5, a vacuum bag 501 or other sealing device may be placed over the heating apparatus 100 to provide a compressive force, when a vacuum is drawn, on the repair patch 405 during heating and to remove gaseous voids and/or solvent that may be trapped within and under the repair patch 405 prior to curing.

FIG. 6 includes damaged substrate 401 having damage 403, patch 405 and heating apparatus 100. As shown in the embodiment of FIG. 6, the heating apparatus 100 may be placed overlying the vacuum bag 501, wherein the vacuum bag 501 is intermediate to the heating apparatus 100 and the patch 405. The vacuum bag 501 is provided and configured to provide a vacuum and exert force on the repair patch 405 and to assist in removal of gaseous voids and/or solvent from the repair during the heat and/or cure cycle.

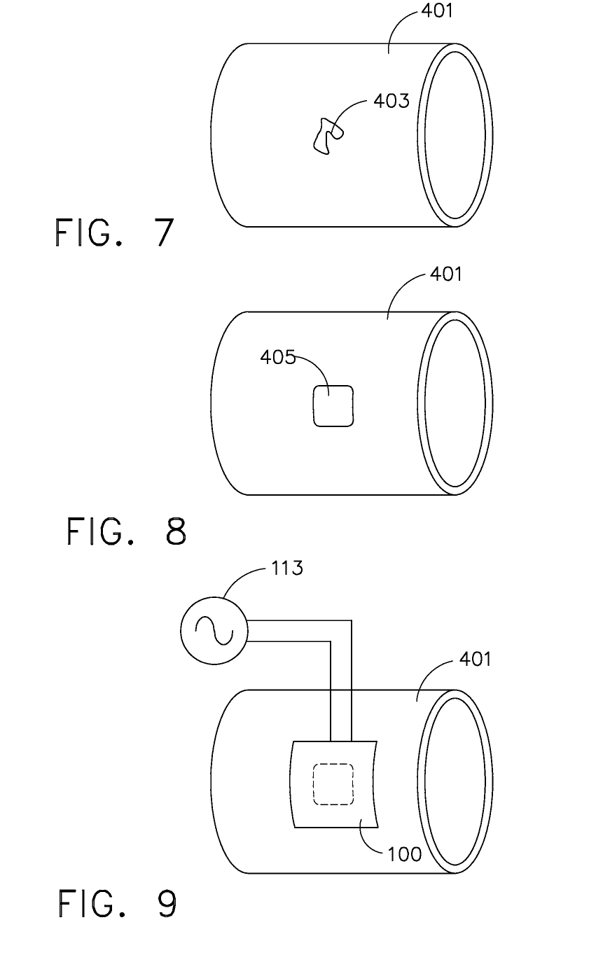

FIGS. 7-9 illustrate a repair method on a damaged substate 401 having a more complex geometry, which is shown as a cylindrical geometry. FIG. 7 shows a perspective view of a damaged substrate 401 having damage 403. FIG. 8 shows the damaged substrate 401 of FIG. 7 having a repair patch 405 placed on the damage 403. FIG. 9 shows a heating apparatus 100 in communication with power source 113 that has been placed on the repair patch 405 of FIG. 8. As described above, the arrangement of FIG. 9 may be placed in a vacuum bag or other device to apply force and assist in removal of gaseous voids and solvent from and under the repair patch 405. The heating apparatus 100 of an embodiment may be utilized on relatively complex geometries including components having rounded or sharp edges and/or features that require uniform heating during repair.

While not required, in addition to the above steps, additional components may be utilized to provide strong, efficient, and reproducible repairs. For example, release material, bleeder material and/or insulation may be provided adjacent the repair patch to provide greater releasability, control of repair patch material and/or heat distribution during heating.

While the embodiment of the disclosure have been described with reference to a preferred embodiment, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof Therefore, it is intended that the embodiments of the disclosure not be limited to the particular embodiment disclosed as the best mode contemplated for carrying any embodiment, but that the disclosure may include all embodiments falling within the scope of the appended claims.

1. A heating apparatus comprising:
a matrix having a surface and magnetic particles, the magnetic particles having a Curie temperature; and
a coil operatively coupled to an alternating current power source, the coil being disposed near the magnetic particles, the coil configured to heat the magnetic particles to a temperature up to about their Curie temperature.

2. The apparatus of claim 1, wherein the heat provided by the matrix is substantially uniform along the surface.

3. The heating apparatus of claim 1, wherein the matrix comprises a high temperature matrix.

4. The apparatus of claim 1, further comprising a controller to regulate current from the power source.

5. The apparatus of claim 1, wherein the predetermined Curie temperature is a temperature from about room temperature to about 650° F.

6. The apparatus of claim 5, wherein the predetermined Curie temperature is a temperature from about 160° F. temperature to about 650° F.

7. The apparatus of claim 6, wherein the predetermined Curie temperature is a temperature from about 250° F. temperature to about 350° F.

8. The apparatus of claim 1, wherein the matrix is selected from the group consisting of polyetheretherketone, polyetherketoneketone and combinations thereof.

9. The apparatus of claim 1, wherein the magnetic particles contain a material selected from the group consisting of magnetite, Cu—Ni—Fe alloys, samarium containing materials, neodymium containing materials and combinations thereof.

10. The apparatus of claim 1, wherein the surface is sealable to a substrate to form a vacuum bag.

11. A method of repairing composite structures comprising:
applying a repair patch to a damaged substrate surface, the repair patch comprising an uncured matrix material and adhesive;
placing a heating apparatus substantially near at least a portion of the repair patch, the heating apparatus comprising:
a matrix having magnetic particles therein, the magnetic particles having a predetermined Curie temperature; and
a coil operatively coupled to a power source, the coil being disposed near the magnetic particles; and
providing an alternating current to the coil sufficient to heat the magnetic particles up to about the predetermined Curie temperature.

12. The method of claim 11, wherein the matrix comprises a high temperature matrix.

13. The method of claim 11, further comprising curing the composite patch with heat generated by the heating apparatus.

14. The method of claim 11, wherein the repair patch comprises a thermoset or thermoplastic material.

15. The method of claim 14, wherein the resin material is selected from the group consisting of epoxy, bismalemide, polyimide, cyanate ester and combinations thereof

16. The method of claim 11, wherein the repair patch further comprises reinforcing fibers.

17. The method of claim 16, wherein the reinforcing fibers are selected from the group consisting of carbon fibers, graphite fibers, boron fibers, silicon carbide fibers, glass fibers, organic fibers and combinations thereof.

18. The method of claim 16, wherein the reinforcing fibers are preimpregnated fibers.

19. The apparatus of claim 11, further comprising a controller to regulate current from the power source.

20. The method of claim 11, wherein the predetermined Curie temperature is a temperatures from about room temperature to about 650° F.

21. The method of claim 20, wherein the predetermined Curie temperature is a temperatures from about 160° F. temperature to about 650° F.

22. The method of claim 21, wherein the predetermined Curie temperature is a of temperatures from about 250° F. temperature to about 350° F.

23. The method of claim 11, wherein the matrix is selected from the group consisting of polyetheretherketone, polyetherketoneketone and combinations thereof.

24. The method of claim 11, wherein the magnetic particles contain a material selected from the group consisting of magnetite, Cu—Ni—Fe alloys, samarium containing materials, neodymium containing materials and combinations thereof.

25. The method of claim 11, wherein the damaged substrate surface is part of a mobile platform.

26. The method of claim 11, further comprising placing a vacuum bag overlying the heating apparatus and the repair patch.

27. The method of claim 11, further comprising placing a vacuum bag intermediate to the heating apparatus and the repair patch.
